(19) United States
(12) Patent Application Publication
(10) Pub. No.: US 2014/0277809 A1
(43) Pub. Date: Sep. 18, 2014

(54) Method and System for Energy Savings

(71) Applicant: Hjalmar Nilsonne, Stockholm (SE)

(72) Inventor: Hjalmar Nilsonne, Stockholm (SE)

(21) Appl. No.: 14/217,363

(22) Filed: Mar. 17, 2014

(30) Foreign Application Priority Data
Mar. 18, 2013 (DE) 1350321-4

(51) Int. Cl. G05F 1/66; G06N 99/00

(52) U.S. Cl. CPC G05F 1/66; G06N 99/005
USPC 700/295; 706/12

(57) ABSTRACT

The present invention relates to a system for energy savings, comprising: an optical reader (2) arranged at an electricity meter (1) connected to a number of loads, which optical reader (2) is configured to in real time optically read a total power consumption measured by said electricity meter (1); communication means (3) operatively connected to said optical reader to transmit read total power consumption; cloud-based analysing means (4), configured to receive the transmitted total power consumption and to analyse the received total power consumption and to break up it into a plurality of separate power consumptions corresponding to a plurality of loads of said number of loads; cloud-based matching means (4), configured to match at least one of said plurality of loads to at least one predetermined alternative load and to calculate an energy saving achieved by utilizing the at least one alternative load instead of said at least one of said plurality of loads; and communication means (5) operatively connected to said cloud-based matching means and configured to transmit information of said alternative load for energy saving to a user of said number of loads.

### CROSS-REFERENCE TO RELATED APPLICATIONS

This application claims priority to SE 1350321-4, filed on Mar. 18, 2013.

### BACKGROUND

The invention relates generally to energy systems, and particularly relates to energy savings in energy systems.

Power consumption is today dependent on a number of different power sources, such as different renewable power sources and different fossil power sources and nuclear power sources. A lot of power is in total consumed in households, and an effective way of reducing the pressure of providing power through a lot of not so desirable power sources, such as fossil power sources and nuclear power sources, would be to get e.g. the households to reduce their power consumption. This is e.g. emphasized by the European Union has set a goal to increase energy efficiency by 20% until 2020. Improving energy efficiency is the best way of reducing climate impact as it is not a cost, it is an investment that generates a profit over time. Households are however generally not interested new energy solutions, which provides a challenge to overcome.

### BRIEF SUMMARY OF THE INVENTION

An object of the present invention is to facilitate for e.g. households to reduce their power consumption.

This object is according to the present invention attained by a method and a system for energy saving, respectively, as defined by the appended claims.

By providing a method for energy savings in an energy system including a number of loads, the method comprising: in real time, optical reading of total power consumption from an electrical meter for the number of loads; transferring the read total power consumption to cloud based means; analysing the total power consumption and breaking up the read total power consumption into a plurality of separate power consumptions corresponding to a plurality of loads of the number of loads; matching at least one of the plurality of loads to at least one predetermined alternative load and calculating an energy saving achieved by utilization of the alternative load instead of the at least one of plurality of loads; and providing a user of the number of loads with information of the predetermined alternative load for energy saving, energy in the system can be saved in very efficient way.

The step of matching preferably comprises matching at least two of the plurality of loads to at least two predetermined alternative loads and calculating energy savings achieved by utilization of the alternative loads instead of the at least two of the plurality of loads; and the step of providing preferably comprises providing a user of the number of loads with information of the at least two predetermined alternative loads and which of the at least two predetermined alternative loads that provides the largest energy saving, whereby it is facilitated for a user to implement the most energy saving action.

By providing a system for energy savings, comprising: an optical reader arranged at an electricity meter connected to a number of loads, which optical reader is configured to in real time optically read a total power consumption measured by the electricity meter; communication means operatively connected to the optical reader to transmit read total power consumption; cloud-based analysing means, configured to receive the transmitted total power consumption and to analyse the received total power consumption and to break up it into a plurality of separate power consumptions corresponding to a plurality of loads of the number of loads; cloud-based matching means, configured to match at least one of the plurality of loads to at least one predetermined alternative load and to calculate an energy saving achieved by utilizing the at least one alternative load instead of the at least one of the plurality of loads; and communication means operatively connected to the cloud-based matching means and configured to transmit information of the alternative load for energy saving to a user of the number of loads, energy in the system can be saved in very efficient way.

The communication means preferably comprises a dedicated device configured to communicate wirelessly with the optical reader over a low energy protocol, particularly a Zigbee protocol or a Bluetooth low energy protocol, in order for the optical reader to be able to operate a long period of time on battery power.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 schematically illustrates a system for energy savings.

FIG. 2 is a flow chart illustrating a method for energy savings.

### DETAILED DESCRIPTION OF THE INVENTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

A system for energy saving according to the present invention will now be described with reference to FIGS. 1 and 2.

The system comprises an optical reader 2 arranged at an electricity meter 1 connected to a number of loads, communication means 3 operatively connected to the optical reader 2, and cloud-based means 4 configured to receive power consumption data from the communication means 3.

The electricity meter 1 is typically an existing meter today arranged in e.g. a household for measuring the total power consumption of the number of loads of the household. One old type of electricity meter has a rotating disc, which is used for a user of the household to be able to in real time verify the power consumption measured by the electricity meter 1. A more modern type of electricity meter has an LED (Light Emitting Diode) typically flashing 1000 times per kWh loading the household. The total power consumption measured by the electricity meter 1 may thus result in many impulses per second, depending on the current total load of the electricity meter 1. Loads of a household may e.g. be direct devices such as heaters, coolers, etc. but may also be indirect devices such as windows, isolation, etc. affecting e.g. heating efficiency, and may further be energy schemes such as in-door temperature, shower/bath utilization, lamp utilization, etc.

The optical reader 2 is arranged at the electricity meter 1, and it is configured to continuously, or in real time, optically read out a total power consumption measured by the electricity meter 1. For optical readout of a rotating disc, a camera is preferably provided with image recognition software to determine the power consumption measured by the electricity meter 1 by determining number of revolutions of the rotating disc. For optical readout of a flashing LED a light sensitive detector is preferably provided to determine the power consumption measure by the electricity meter 1 by determining number of flashes/impulses. By optically reading out the total power consumption of the number of loads of the household a cost effective installation may be used for existing electricity meters.

The optical reader 2 is preferably attached to the electricity meter 1 by an adhesive patch. By alternatively attaching the optical reader 2 to the electricity meter 1 through Velcro means, readjustment of its position over the LED is facilitated, which provides for the optical reader 2 to be well defined positioned over the LED of the electricity meter 1. Yet alternative, the optical reader may be attached by mechanical means to the electricity meter 1. For communicating the total power consumption determined by the optical reader 2 to the cloud-based means 4, several different solutions may be utilized. The optical reader 2 is advantageously driven by battery, to not require connection to a power supply at the electricity meter 1 and thereby facilitate attachment thereto. To further facilitate attachment of the optical reader 2 to the electricity meter 1, the optical reader 2 preferably communicates wirelessly the cloud-based means 4. To minimize power consumption from the optical reader 2, and to provide sufficient real time data transfer capability, a communication means 3 is arranged between the optical reader 2 and the cloud-based means 4. The communication means 3 preferably comprises a dedicated device configure to wirelessly receive total power consumption from the optical reader 2 through a low energy protocol. The dedicated device can in turn be connected to an existing Internet router at the household, via e.g. WiFi or via cable. The dedicated device preferably utilizes a Zigbee protocol to communicate wirelessly with the optical device 2, and may be arranged close to an existing power socket. The dedicated device may e.g. alternatively utilize a Bluetooth low energy protocol to communicate wirelessly with the optical device 2.

Alternative communication means 3 between the optical reader 2 and the cloud-based means 4 may e.g. be provided inbuilt in the optical reader 2 connected through a cable or WiFi to an existing Internet router of the household, or be provided through a cellular data connection directly connected to, or inbuilt into, the optical reader 2.

By providing a cloud-based means 4, maintaining well organized databases of the total power consumption for one or more of a plurality of households are e.g. achieved. The cloud-based means 4 comprise both cloud-based analysing means 4 as well as cloud-based matching means 4. The cloud-based means 4 may e.g. be provided by distributed processing recourse or a centralized server or servers.

The cloud-based analysing means 4 is configured to receive the transmitted total power consumption sent from communication means 3 and to continuously store the total power consumption for a household. The cloud-based analysing means 3 is further configured to break up the total power consumption of a household into a plurality of separate power consumptions corresponding to a plurality of loads of the number of loads of the household. By having a real-time measurement of the total power consumption, a well defined break down of the total power consumption into a plurality of separate power consumptions corresponding to separate loads of a household is facilitated. The analysis and break down is preferably based on machine learning, but may alternatively be based on other computational methods such as artificial intelligence. The machine learning preferably utilizes a Hidden Markov Chain Models (HMCM). In order for the machine learning to establish a well defined break down of the power consumption into a plurality of corresponding loads, all read total power consumption is stored for a period of time in the database. Major power consuming loads such as heating may be identified already after a short period of time such as a couple of hours, whereas loads related to schemes may require longer period of times, such as hot water consumption schemes typically having weekly patterns.

With larger datasets (aggregated over time) the patterns of each household, and the aggregated data for many households, will reveal clearer patterns of behavior and the disaggregation will become better into e.g. type of area, house, number of children etc. The more trends/tendencies that are general for an area, the better estimates can be made for each household. A database is preferably also made for different types of appliances, such as type of washing machine or washing program. It is also possible to add a probability based on previously used devices. If we see that food has been made by utilization of oven or stove, the probability of using the dishwasher is higher than on average. Furthermore, when almost no devices are in use, such as during the night, identification of standby consumption and “always on” devices such as fridges is facilitated.

The cloud-based matching means 4 is configured to match at least one of the plurality of loads to at least one predetermined alternative load and to calculate an energy saving achieve by utilizing a matched predetermined alternative load instead of the at least one of the plurality of loads. The predetermined alternative loads are preferably retrieved/received from third parties 5 marketing power consuming devices such as heaters, fridges, freezers, stoves, ovens, dish washers, and tumblers, or from data of neighbouring or similar households. A further predetermined alternative load could e.g. be a different utilization scheme for a load, such as a different in-door temperature for different periods of time of day, less shower/bath utilization and less lamp utilization. Further, when considering costs for power consumptions, predetermined alternative loads for schemes may include e.g. shower/bath utilization and lamp utilization during different periods of time of day. When a match of one or more of plurality of loads is found for one or more predetermined alternative load, an energy saving is calculated based on the load being exchanged with the alternative load. This energy saving may also be transformed into a cost saving based on current energy costs.

The cloud-based matching means 4 is preferably also configured to provide a sponsoring market place, whereby e.g. an environmental organisation can invest money to e.g. provide users with very advantageous offers on e.g. fridges for energy saving, which would lead to a total larger energy efficiency.

Advantageously, the system is configured to match at least two predetermined alternative loads corresponding to energy savings for at least two separate loads of the plurality of loads. The system is in this case configured to provide the user with information of the at least two cost savings as well as information of which of the cost savings that are the largest cost saving, preferably as a list sorted on cost savings.

The system is preferably also configured to track and store power consumption for a matched load and a corresponding alternative load over a period of time, and configure to provide a user of the number of loads with information of the tracked power consumption. In this way the user has the possibility to see the effect of exchanging a loading device or the effect of exchanging a loading scheme. A user is often used to receive a monthly invoice from a power supplier, and the tracked difference is advantageously also divided into monthly energy savings for the tracked power consumption. To facilitate for the user to interpret the benefit of an energy saving, a corresponding cost saving is preferably provided to the user.

Communication means 5 is operatively connected to the cloud-based matching means 4 to transmit information of the alternative load and the corresponding energy saving to a user of the number of loads. Communication means 5 is preferably an Internet interface arrangement for the cloud-based matching means 4. The information is preferably provided to the user through user logging in to a secure website, but may alternative be provided to the user by other means such as email, mail or together with a regular bill for energy costs. The information about the amount of energy saving is preferably transformed into a cost saving based on current energy costs.

The system is preferably also configured to store determined energy savings or cost savings, such that a user may be provided with information how much costs saving a predetermined alternative load has saved since identified.

The system is preferably configured to exchange a load of said number of loads with a matched alternative load. Example of such an exchange of load is to switch off one or more lights, based on identified or estimated presence of a user of the household.

Advantageously, the system is further configured to provide a user with a possibility to compare his own energy consumptions with e.g. other within his closest area, within his country, or even with Other countries. The system is preferably also configured to provide a user with an incentive program, wherein energy savings may provide the user with e.g. a trip for the whole family. Similarly thereto, a point system may be utilized wherein points may be saved for different actions, which accumulated points thereafter can be traded for various rewards, such as e.g. an energy effective light bulb or a high reward level with can be posted on a public forum such as Facebook or in a semi-public forum such as in applications. Also similarly thereto, social responsibility may be supported by giving a part of saved cost for the user to a project for someone in need, such as e.g. solar panels to a hospital in poor African countries. The amount of such transferred funds may further be connected to the household, which taken social responsibility may be recognized in a community.

A method for energy savings in the system comprises the following steps.

In real time, optical reading 10 of total power consumption from the electrical meter for the number of loads. Transferring the read total power consumption to cloud-based means. Analysing the total power consumption and breaking up 11 the read total power consumption into a plurality of separate power consumptions corresponding to a plurality of loads of the number of loads. Matching 12 at least one of the plurality of loads to at least one predetermined alternative load and calculating an energy saving achieved by utilization of the alternative load instead of the at least one of plurality of loads. Providing 13 a user of the number of loads with information of the predetermined alternative load for energy saving.

The step of matching 12 preferably comprises matching of at least two of the plurality of loads to at least two predetermined alternative loads and calculating energy savings achieved by utilization of the at least two alternative loads instead of the at least two of the plurality of loads, and providing 13 a user of the number of loads with information of the at least two predetermined alternative loads and which of the at least two predetermined alternative loads that provides the largest energy saving. For a case with more than two matched loads, providing a list of matched loads sorted by largest energy saving. An energy sawing may be transferred to a cost saving based on current energy cost, for informing a user of a number of loads.

The method preferably additionally comprises exchanging a load of the number of loads with a matched alternative load, such a device matched from a third party device.

The method preferably additionally comprises tracking and storing power consumption for a matched load and a corresponding alternative load over a period of time, and providing a user of the number of loads with information of the tracked power consumption.

Further, the method advantageously comprises additionally steps to perform one or more actions of the system described above.

The invention has mainly been described above with reference to a few embodiments. However, as is readily appreciated by a person skilled in the art, other embodiments than the ones disclosed above are equally possible within the scope of the invention, as defined by the appended patent claims.

What is claimed is:

1. A method for energy savings in an energy system including a number of loads, said method comprising:
in real time, optical reading (10) of a total power consumption from an electrical meter for said number of loads;
transferring a read total power consumption to a cloud-based means;
analysing said total power consumption and breaking up (11) the read total power consumption into a plurality of separate power consumptions corresponding to a plurality of loads of said number of loads;
matching (12) at least one of said plurality of loads to at least one predetermined alternative load and calculating an energy saving achieved by utilization of the alternative load instead of said at least one of plurality of loads; and
providing (13) a user of said number of loads with information of the predetermined alternative load for energy saving.

2. The method according to claim 1, additionally comprising:
matching (12) at least two of said plurality of loads to at least two predetermined alternative loads and calculating energy savings achieved by utilization of the alternative loads instead of the at least two of said plurality of loads; and
providing (13) a user of said number of loads with information of the at least two predetermined alternative loads and which of said at least two predetermined alternative loads that provides the largest energy saving.

3. The method according to claim 1, additionally comprising exchanging a load of said number of loads with a matched alternative load.

4. The method according to claim 1, wherein said step of analysing and breaking up is based on machine learning, preferably based on a Hidden Markov Chain Model.

5. The method according to claim 1, additionally comprising transferring total power consumption from an optical reader wirelessly to a dedicated device over a low energy protocol, preferably a Zigbee protocol or a Bluetooth low energy protocol.

6. The method according to claim 1, wherein the predetermined loads are retrieved from a database external to the energy system.

7. The method according to claim 1, additionally comprising publishing information about an alternative load and its corresponding energy saving on a secure website.

8. The method according to claim 1, additionally comprising tracking and storing power consumption for a matched load and a corresponding alternative load over a period of time; and providing (13) a user of said number of loads with information of the tracked power consumption.

9. A system for energy savings, comprising:
an optical reader (2) arranged at an electricity meter (1) connected to a number of loads, the optical reader (2) is configured to in real time optically read a total power consumption measured by said electricity meter (1);
a communication means (3) operatively connected to said optical reader to transmit read total power consumption;
a cloud-based analysing means (4), configured to receive the transmitted total power consumption and to analyse the received total power consumption and to break up it into a plurality of separate power consumptions corresponding to a plurality of loads of said number of loads;
a cloud-based matching means (4), configured to match at least one of said plurality of loads to at least one predetermined alternative load and to calculate an energy saving achieved by utilizing the at least one alternative load instead of said at least one of said plurality of loads; and
a communication means (5) operatively connected to said cloud-based matching means and configured to transmit information of said alternative load for energy saving to a user of said number of loads.

10. The system according to claim 9, wherein said matching means (4) is configured to match at least two of said plurality of loads to at least two predetermined alternative loads and to calculate energy savings achieved by utilization of the at least two predetermined alternative loads instead of the at least two of said plurality of loads; and said communication means (5) is configured to transmit information of said at least two predetermined alternative loads and which of said at least two predetermined alternative loads that provides the largest energy saving.

11. The system according to claim 9, wherein said system is configured to exchange a load of said number of loads with a matched alternative load.

12. The system according to claim 9, wherein said cloud-based analysing means is configured to analyse and break up the received total power consumption based on machine learning, preferably based on a Hidden Markov Chain Model.

13. The system according to claim 9, wherein said communication means (3) comprises a dedicated device configured to communicate wirelessly with said optical reader (2) over a low energy protocol, preferably a Zigbee protocol or a Bluetooth low energy protocol.

14. The system according to claim 9, wherein said communication means (5) is configured to publish information about an alternative load and its corresponding energy saving on a secure website.
